(19) United States
(12) Patent Application Publication
(10) Pub. No.: US 2006/0178926 A1
(43) Pub. Date: Aug. 10, 2006

(54) Monitor for reorganizations on the level of organizational units

(76) Inventors: Martin H. Kaisermayr, Antibes (FR); Andy Peichl, Ubstadt-Weiher (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/052,205

(22) Filed: Feb. 8, 2005

(51) Int. Cl. G06F 15/02

(52) U.S. Cl. 705/9

(57) ABSTRACT

Embodiments consistent with the invention provide a computer-implemented method for monitoring organizational change. The method comprises electronically receiving first input data containing a change request relating to a personnel position within an organization's structure, electronically receiving second input data containing a notification request, wherein the notification request specifies an organizational change that should be monitored, electronically storing the second input data in a record, electronically determining a type of organizational change based on the change request, and electronically performing a task based on the type of organizational change and on a comparison between the change request and the specified organizational change.

### CROSS-REFERENCE TO RELATED APPLICATIONS

This application is related to U.S. patent application entitled “Method and System for Monitoring Conditions for Organizational Change” by Martin H. Kaisermayr, which was filed on a date even herewith and is incorporated herein by reference in its entirety.

### TECHNICAL FIELD

The present invention generally relates to reorganizations of business institutions, and, more particularly, to systems and methods for reducing the overhead required for such reorganizations.

### BACKGROUND

For business organizations, such as corporations, restructuring is often necessary to stay competitive in today's dynamic and expanding business environment. However, changes in the organizational structure of an institution, such as complete omission or partial elimination of personnel positions, cannot always be put into practice immediately as long as the positions are still occupied by employees, due to legal requirements or internal business policies.

Hence, implementing such reorganizations requires increased organizational effort by administrative personnel to determine when an organizational change can be performed. Therefore, there is a need in the art of organization restructuring to reduce the overhead needed to change an organization's structure.

### SUMMARY

Accordingly, embodiments consistent with the present invention relate to monitoring systems and methods that may alleviate one or more of the limitations or disadvantages existing in the related art.

Embodiments consistent with the invention provide a computer-implemented method for monitoring organizational change. The method comprises electronically receiving first input data containing a change request relating to a personnel position within an organization's structure, electronically receiving second input data containing a notification request, wherein the notification request specifies an organizational change that should be monitored, electronically storing the second input data in a record, electronically determining a type of organizational change based on the change request, and electronically performing a task based on the type of organizational change and on a comparison between the change request and the specified organizational change.

Embodiments consistent with another aspect of the invention also provide a computer program product including instructions for execution by a processor to perform a method for monitoring organizational change. The method comprises electronically receiving first input data containing a change request relating to a personnel position within an organization's structure, electronically receiving second input data containing a notification request, wherein the notification request specifies an organizational change that should be monitored, electronically storing the second input data in a record, electronically determining a type of organizational change based on the change request, and electronically performing a task based on the type of organizational change and on a comparison between the change request and the specified organizational change.

Embodiments consistent with yet another aspect of the invention further provide a system for monitoring organizational change. The system comprises a component for electronically receiving first input data containing a change request relating to a personnel position within an organization's structure, a component for electronically receiving second input data containing a notification request, wherein the notification request specifies an organizational change that should be monitored, a component for electronically storing the second input data in a record, a component for electronically determining a type of organizational change based on the change request, and a component for electronically performing a task based on the type of organizational change and a comparison between the change request and the specified organizational change.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the invention.

FIG. 1 illustrates an exemplary system environment in which the features of the present invention may be implemented.

FIG. 2 is an exemplary flowchart of a process for monitoring reorganizations on the level of organizational units, consistent with the principles of the present invention.

FIG. 3 is an exemplary structure of a request for notification consistent with the principles of the present invention.

FIG. 4 is an exemplary flowchart of a more detailed process for monitoring reorganizations on the level of organizational units, consistent with the principles of the present invention.

### GLOSSARY OF TERMS

As used in the description herein, “organizational unit,” in the context of an organization, refers to a group of employee positions having a common title, such as “associate” or “management consultant,” etc. or belong to a common organizational group, such as a department or subsidiary. “Completely free,” in the context of an organizational position, refers to the organization not having any employees occupying the position. “Partially free,” in the same context, refers to the organization having some employees but not all the employees that can occupy the position. “Increase,” in the context of an organizational position, refers to an increase in the status of the position, such as an increase in pay or responsibility of an employee occupying the position, an increase in hours worked by an employee occupying the position, an increase in the billable rate of an employee occupying the position, and/or filling the position with an employee and thereby increasing the number of employees occupying the position, etc. Finally, “decrease,” in the context of an organizational position, refers to a decrease in the status of the position, such as a decrease in pay or responsibility of an employee occupying the position, a decrease in hours worked by an employee occupying the position, a decrease in the billable rate of an employee occupying the position, and/or removing an employee from the position and thereby decreasing the number of employees occupying the position, etc.

### DETAILED DESCRIPTION OF THE EMBODIMENTS

Reference will now be made in detail to exemplary embodiments consistent with the invention, examples of which are illustrated in the accompanying drawings. Wherever possible, the same reference numbers will be used throughout the drawings to refer to the same or like parts.

The following detailed description refers to the accompanying drawings. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering or, adding steps to the disclosed methods. Accordingly, the following detailed description does not limit the invention.

Embodiments consistent with the present invention are directed to systems, methods, and computer-readable media for monitoring organizational change. Embodiments consistent with the invention may be implemented in various environments, including computer-based environments, such as personal computers, workstations, servers, laptops, personal digital assistants (PDAs), mobile phones, handheld devices, and other computing devices, workstation, networked and other computing-based environments with one or more users. The present invention, however, is not limited to such examples and embodiments consistent the invention may be implemented with other platforms and in other environments.

By way of example, embodiments consistent with the invention may be implemented using conventional personal computers (PCs), desktops, hand-held devices, multiprocessor computers, pen computers, microprocessor-based or programmable consumer electronics devices, minicomputers, mainframe computers, personal mobile computing devices, mobile phones, portable or stationary personal computers, palmtop computers or the like.

The storage media referred to herein symbolize elements that temporarily or permanently store data and instructions. Although storage functions may be provided as part of a computer, memory functions can also be implemented in a network, processors (e.g., cache, register), or elsewhere. Various types of storage mediums can be used to implement features of the invention, such as a read-only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); (c) semiconductor media, like DRAM, SRAM, EPROM, EEPROM, memory stick, and/or by any other media, like paper.

Embodiments consistent with the invention may also include computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, intranets and the Internet (i.e., the World Wide Web). The network may be a wired or a wireless network. To name a few network implementations, the network may be, for example, a local area network (LAN), a wide area network (WAN), a public switched telephone network (PSTN), an Integrated Services Digital Network (ISDN), an infrared (IR) link, a radio link, such as a Universal Mobile Telecommunications System (UMTS), Global System for Mobile Communication (GSM), Code Division Multiple Access (CDMA), or a satellite link.

Systems, methods, and computer-readable media consistent with the present invention may reduce the overhead needed to implement changes in an organization's structure. Consequently, systems, methods, and computer readable media consistent with the present invention monitor changes to an organization's structure, such as when an employee occupies or leaves a position, or a new position is created and, in response to such changes, performs a specified action. More specifically, systems, methods, and computer readable media consistent with the present invention monitor changes to an organization's structure and determine if such changes match any of the changes listed in submitted requests for notification. If a match is found, a specified action is performed.

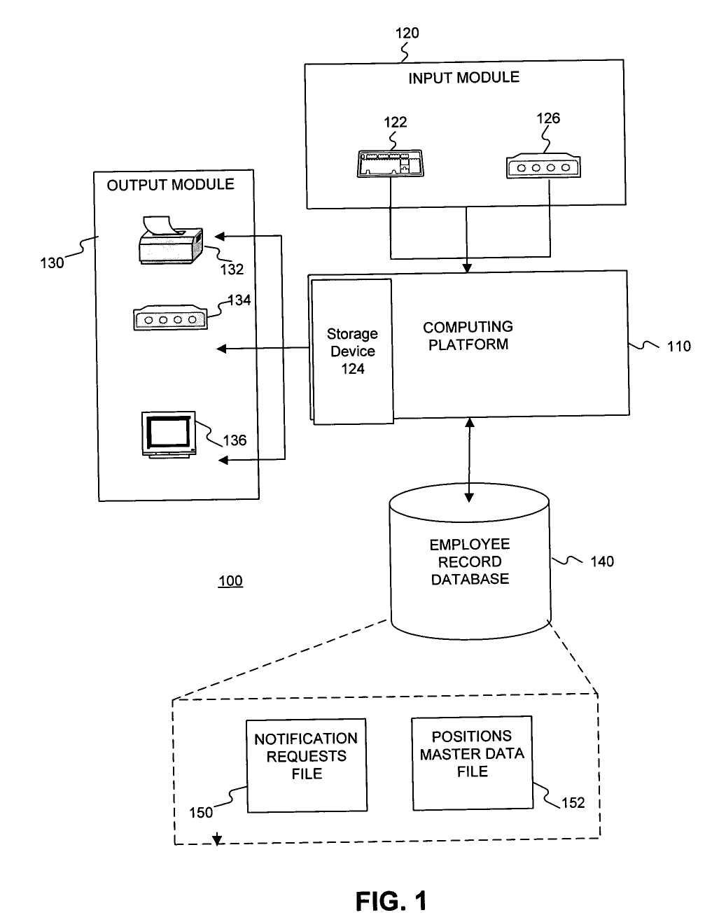

FIG. 1 illustrates an exemplary system environment 100, consistent with the present invention for use in an organization. As illustrated in FIG. 1, system 100 includes a computing platform 110, an input module 120, an output module 130, and an employee record database 140. Computing platform 110 is adapted to process input information received from input module 120. Computing platform 110 is further adapted to provide output information to output module 130. Additionally, computing platform 110 is adapted to access information in employee record database 140 for use in performing methods consistent with the present invention (discussed below).

Computing platform 110 may comprise a general purpose computer (e.g., a personal computer, network computer, server, or mainframe computer) having a processor that may be selectively activated or reconfigured by a computer program to perform one or more methods consistent with the present invention. Computing platform 110 may also be implemented in a distributed network. Alternatively, computing platform 110 may be specially constructed for carrying-out methods consistent with the present invention.

Input module 120 may include an input device 122 and/or an network interface 126. Input device 122 may be implemented using a keyboard, mouse, speech recognition device, or data entering devices. Network interface 126 may receive information over any type of network (not shown), such as a telephony-based network (e.g., PBX or POTS), a local area network, a wide area network, a dedicated intranet, and/or the Internet. Computing platform 110 may also access data stored on storage device 124. Storage device 124 may include a memory, such as RAM or ROM memory that contains instructions or data for performing one or more methods consistent with the present invention.

In monitoring changes to the organization's structure, input module 120 may be used to enter or obtain both information about changes in an organization's structure and notification requests that specify changes which are to be monitored. Such information and requests may be obtained, for example, from an employee, from storage device 124, or from another computing system via network interface 126. Computing platform 110 may then store the information received from input module 120 in employee record database 140.

As described below, computing platform 110 uses the stored organizational structure and notification requests to monitor changes in the organization's structure using methods consistent with the present invention. Computing platform 110 also provides notifications and/or alerts to output module 130. Output module 130 in turn outputs the received information to interested parties internally or for assisting the interested parties.

Output module 130 may include a printer 132, an output interface 134, and/or a display 136. Printer 132 may be used to provide a list of proposed actions (discussed below) and other information to interested parties. Output interface 134 may be used to provide the list of proposed actions and other information to the interested parties via the Internet, email, fax, page, or to save the information on a computer readable medium. Display 136 may be used to provide the list of proposed actions and other information to the interested parties visually.

Employee record database 140 may include a notification requests file 150 (discussed below) and a positions master data file 152. Positions master data file 152 preferably includes a record of all the positions in a organization and the employees occupying such positions. This data may include, for example, information regarding the title of these positions, the salary of the employees occupying such positions, the number of hours worked at these positions, etc. The information to be entered in files 150 and 152 may be entered or obtained using input module 120.

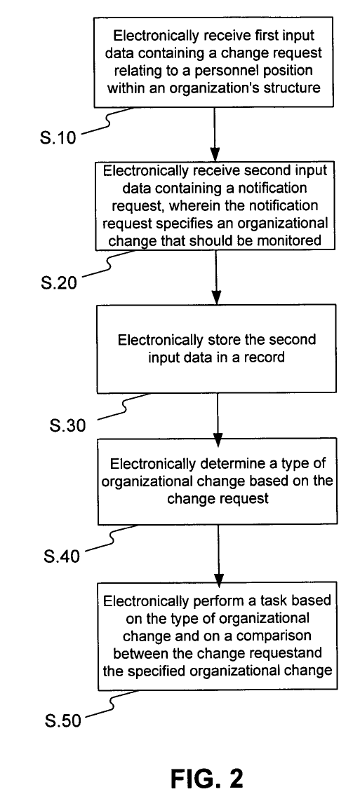

FIG. 2 illustrates an exemplary flowchart of a process for monitoring reorganizations on the level of organizational units, consistent with the principles of the present invention. Although the steps of the monitor process are described as being performed in a particular order, one skilled in the art will appreciate that these steps may be performed in a modified or different order. Further, one or more of the steps in FIG. 2 may be performed concurrently or in parallel.

First, computing platform 110 electronically receives first input data containing a change request calling for a change to positions master data file 152 (Step S.10). In one embodiment, computing platform 110 can receive the change request via network interface 126 from another computing system. In an alternative embodiment, computing platform 110 can receive the change request from an employee at the organization who can enter the change request via input device 122.

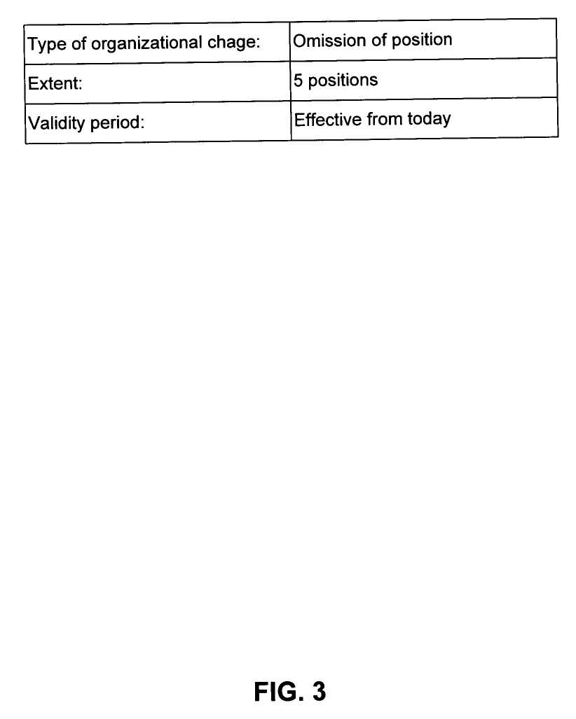

Next, computing platform 110 electronically receives second input data containing a notification request (Step S.20) and stores the notification request in notification requests file 150 (Step S.30). Notification requests are submitted by organizational units to indicate which organizational changes should be monitored, the length of time they should be monitored, and what actions to take when such changes occur. For example, suppose a university plans to eliminate a certain number of positions to decrease personnel expenditures on a long-term basis. The management of the university decides to reduce the staff of the library by five positions. However, since all positions of the library are occupied and since it is desired to avoid terminations, no position can be deleted immediately. The university administration decides that the monitor process should work in the background and notify the persons responsible for implementing the reduction by email. An exemplary structure of a request for notification that could be submitted by the university containing the type and extent of the organizational change, consistent with the principles of the present invention, is shown in FIG. 3. The purpose for reporting issues may also be contained in the request and may include reasons why the organizational position is being monitored, such as to reduce expenses, to implement corporate down-sizing, etc.

In one embodiment, records in notification requests file 150 can have multiple states, as shown in Table 1 below. For example, in reference to the university planning example of FIG. 3, the notification request would initially be in the “red” state. At the time a first position conforming to the requirements of the notification request became completely or partially free and the specified action was performed (discussed below), the notification request would enter the “yellow” state. Finally, when the fifth position meeting the requirements becomes free and the specified action is performed, the notification request would go to the “green” state. One skilled in the art will appreciate that countless other states may be used.

TABLE 1
Notification Request

| | |
|---|---|
| Red | Not realized at all after being issued on the |
| | organizational unit |
| Yellow | Partially realized (this state is obtained as |
| | soon as the first change has been applied) |
| Green | Completely realized (this state is obtained |
| | when the organizational changes have |
| | been put into practice) |

Returning to FIG. 2, computing platform 110 then electronically determines the type of organization change that is requested (Step S.40). Finally, computing platform 110 electronically performs a task based on the type of organizational change and on a comparison between the change request and the specified organization changes stored in notification requests file 150 (Step S.50).

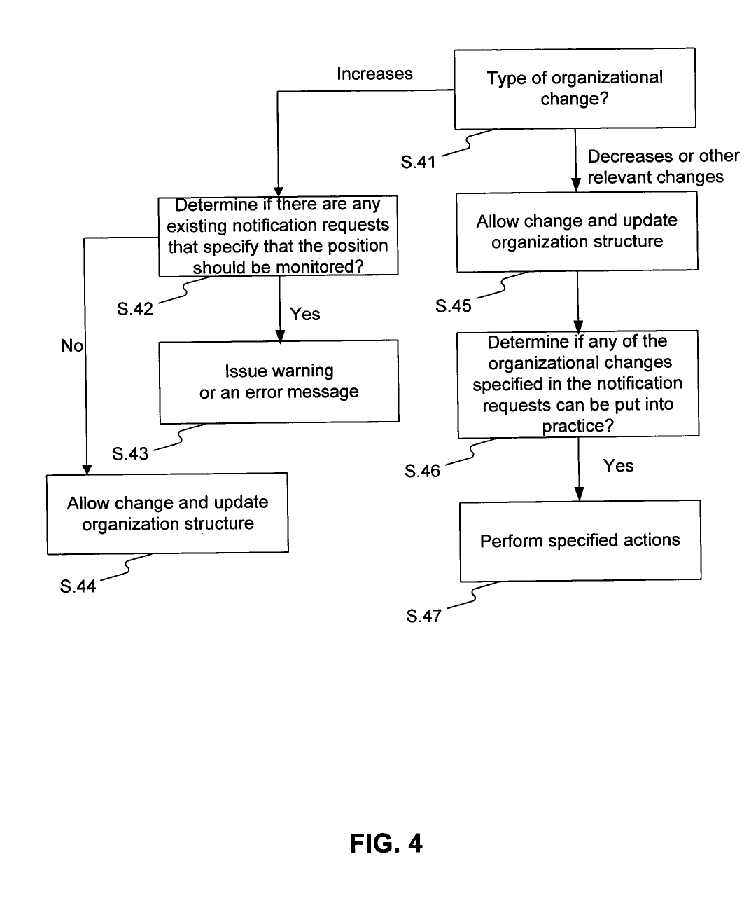

A more detailed version of step S.50 is shown in FIG. 4. If the change request (S.41) involves an increase in an organizational position, then computing platform 110 checks if any records in notification requests file 150 exist that specify that the position for which the change is requested should be monitored (step S.42). For example, in reference to the university planning example of FIG. 3, if computing platform 110 received a change request of increasing the pay for the staff of the library or hiring of a new employee to completely or partially fill a library staff position, computing platform 110 would check if any records in notification requests file 150 were interested in monitoring the library staff positions.

If there are any records in notifications requests file 150 that specify that the position (for which a change is requested) should be monitored, then computing platform 110 issues a warning or an error message depending on system customizations (step S.43). For example, in reference to the university planning example, computing platform 110 would find the exemplary notification request submitted by the university management of FIG. 3, when the change request involved an increase in pay for the library staff or hiring of a new employee to completely or partially fill a library staff position, and would issue a warning or an error message. A warning or an error message would be issued because an increase in pay or hiring of a new employee to completely or partially fill a library staff position conflicts with the submitted notification request that desires to reduce staff and reduce expenses. However, if there are not any notification requests interested in the position for which the change is requested, the change is allowed and recorded in positions master data file 152 (Step S.44).

Alternatively, if the change request involves a decrease in an organizational position or any other relevant change, then computing platform 110 allows the change and records the change in positions master data file 152 (Step S.45) and then checks if the newly created state of the position allows putting into practice any of the organizational changes specified in notification requests (step S.46). For example, if the change to the organizational position enabled a position belonging to the relevant organizational unit to become completely free, this would allow the complete or partial realization of notification requests for omitting or restricting that position. Alternatively, if a change to the organizational position enabled a position belonging to the relevant organizational unit to become partially free, this would allow the complete or partial realization of notification requests for restricting that position.

If it is found that an organizational change specified by the notification request can be put into practice, then the specified actions within the notification request are performed (step S.47). Some examples of actions that could be performed include the deletion of the position, a decrease in the position, a restriction on the position, etc. Computing platform 110 could generate a message via display 136, proposing to the user, who has applied the changes leading to that state, to perform the specified actions. Alternatively, computing platform 110 could perform the specified actions automatically or temporarily block the position for reoccupation and trigger a workflow, such as, for example, by sending an email to the person responsible to implement these actions via output module 130. As soon as the action has been performed on the position, computing platform 110 adds to the notification request an entry specifying the date, type of organizational change and the ID of the position on which the change has been performed.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for monitoring organizational change comprising:
electronically receiving first input data containing a change request relating to a personnel position within an organization's structure;
electronically receiving second input data containing a notification request, wherein the notification request specifies an organizational change that should be monitored;
electronically storing the second input data in a record;
electronically determining a type of organizational change based on the change request; and
electronically performing a task based on the type of organizational change and on a comparison between the change request and the specified organizational change.

2. The method of claim 1, wherein the step of receiving second input data comprises receiving a notification request further including a specified action.

3. The method of claim 2, wherein electronically performing a task comprises performing different tasks based on whether the type of organization change is an increase to the personnel position or a decrease to the personnel position.

4. The method of claim 3, wherein electronically performing a task comprises performing the specified action automatically if the type of organizational change is a decrease to the personnel position and if the change request satisfies the specified organizational change.

5. The method of claim 3, wherein electronically performing a task comprises temporarily blocking the personnel position for reoccupation and triggering a workflow to a person responsible to perform the specified action, if the type of organizational change is a decrease to the personnel position and if the change request satisfies the specified organizational change.

6. The method of claim 3, wherein electronically performing a task comprises proposing to a user associated with the change request to perform the specified action, if the type of organizational change is a decrease to the personnel position and if the change request satisfies the specified organizational change.

7. The method of claim 1, wherein the step of receiving second input data comprises receiving a notification request further containing a period of time.

8. The method of claim 7, wherein electronically performing a task comprises not considering the notification request after the period of time expires.

9. The method of claim 1, wherein the step of receiving second input data comprises receiving a notification request further containing a state identifier.

10. The method of claim 4, wherein electronically performing a task comprises adding to the notification request an entry specifying the date, the type of organizational change, and an ID of the personnel position on which the specified action has been performed after performing the specified action.

11. A computer program product including instructions for execution by a processor to perform a method for monitoring organizational change, the method comprising:
electronically receiving first input data containing a change request relating to a personnel position within an organization's structure;
electronically receiving second input data containing a notification request, wherein the notification request specifies an organizational change that should be monitored;
electronically storing the second input data in a record;
electronically determining a type of organizational change based on the change request; and
electronically performing a task based on the type of organizational change and on a comparison between the change request and the specified organizational change.

12. The method of claim 11, wherein the step of receiving second input data comprises receiving a notification request further including a specified action.

13. The method of claim 12, wherein electronically performing a task comprises performing different tasks based on whether the type of organization change is an increase to the personnel position or a decrease to the personnel position.

14. The method of claim 13, wherein electronically performing a task comprises performing the specified action automatically if the type of organizational change is a decrease to the personnel position and if the change request satisfies the specified organizational change.

15. The method of claim 13, wherein electronically performing a task comprises temporarily blocking the personnel position for reoccupation and triggering a workflow to a person responsible to perform the specified action, if the type of organizational change is a decrease to the personnel position and if the change request satisfies the specified organizational change.

16. The method of claim 13, wherein electronically performing a task comprises proposing to a user associated with the change request to perform the specified action, if the type of organizational change is a decrease to the personnel position and if the change request satisfies the specified organizational change.

17. The method of claim 11, wherein the step of receiving second input data comprises receiving a notification request further containing a period of time.

18. The method of claim 17, wherein electronically performing a task comprises not considering the notification request after the period of time expires.

19. The method of claim 11, wherein the step of receiving second input data comprises receiving a notification request further containing a state identifier.

20. The method of claim 14, wherein electronically performing a task comprises adding to the notification request an entry specifying the date, the type of organizational change, and an ID of the personnel position on which the specified action has been performed after performing the specified action.

21. A system for monitoring organizational change comprising:
a component for electronically receiving first input data containing a change request relating to a personnel position within an organization's structure;
a component for electronically receiving second input data containing a notification request, wherein the notification request specifies an organizational change that should be monitored;
a component for electronically storing the second input data in a record;
a component for electronically determining a type of organizational change based on the change request; and
a component for electronically performing a task based on the type of organizational change and on a comparison between the change request and the specified organizational change.

22. The system of claim 21, wherein the component for receiving second input data comprises receiving a notification request further including a specified action.

23. The system of claim 22, wherein the component for electronically performing a task comprises performing different tasks based on whether the type of organization change is an increase to the personnel position or a decrease to the personnel position.

24. The system of claim 23, wherein the component for electronically performing a task comprises performing the specified action automatically if the type of organizational change is a decrease to the personnel position and if the change request satisfies the specified organizational change.

25. The system of claim 23, wherein the component for electronically performing a task comprises temporarily blocking the personnel position for reoccupation and triggering a workflow to a person responsible to perform the specified action, if the type of organizational change is a decrease to the personnel position and if the change request satisfies the specified organizational change.

26. The system of claim 23, wherein the component for electronically performing a task comprises proposing to a user associated with the change request to perform the specified action, if the type of organizational change is a decrease to the personnel position and if the change request satisfies the specified organizational change.

27. The system of claim 21, wherein the component for receiving second input data comprises receiving a notification request further containing a period of time.

28. The system of claim 27, wherein the component for electronically performing a task comprises not considering the notification request after the period of time expires.

29. The system of claim 21, wherein the component for receiving second input data comprises receiving a notification request further containing a state identifier.

30. The system of claim 24, wherein the component for electronically performing a task comprises adding to the notification request an entry specifying the date, the type of organizational change, and an ID of the personnel position on which the specified action has been performed after performing the specified action.
